(19) United States
(12) Patent Application Publication
(10) Pub. No.: US 2018/0097319 A1
(43) Pub. Date: Apr. 5, 2018

(54) Electrical Cord and Charger Organizer

(71) Applicant: Fonglui Christopher Ng, San Diego, CA (US)

(72) Inventor: Fonglui Christopher Ng, San Diego, CA (US)

(21) Appl. No.: 15/724,739

(22) Filed: Oct. 4, 2017

Related U.S. Application Data
(60) Provisional application No. 62/404,494, filed on Oct. 5, 2016.

(51) Int. Cl. H01R 13/72

(52) U.S. Cl. CPC H01R 13/72

(57) ABSTRACT

The present application generally relates to electrical cord and cable organizing apparatuses. Specifically, the invention relates to an apparatus that not only bundles an electrical cord or cable, but also an attached AC/DC adapter into a compact form. Further embodiments of the invention also provides for conveniently packing AC/DC adapters of various shapes and sizes into compact packages.

### CROSS REFERENCE TO RELATED APPLICATIONS

The present application claims priority to provisional application No. 62/404,494, entitled “Electrical Cord Organizing Device”, filed on Oct. 5, 2016, the contents of which are incorporated by reference herein in their entirety.

### FIELD OF THE INVENTION

The present application generally relates to electrical cord and cable organizing apparatuses. Specifically, the invention relates to an apparatus that not only bundles an electrical cord or cable (hereafter “cord”), but also an attached AC/DC adapter, into a compact form. Further embodiments of the invention also provides for conveniently packing AC/DC adapters of various shapes and sizes into compact packages.

### BACKGROUND

As personal electronic devices proliferate, so are electrical cords and battery chargers. A battery charger is typically comprised of a cord and an AC/DC adapter. Traditionally, people wind the cords in their hands and tie them with rubber bands or Velcro bands. Recently, a number of variations have appeared on the commercial market. However, few, if any, apparatuses also bundle the AC/DC adapter along with the cord. The present invention is designed so that the often bulky AC/DC adapter is bundled together with the cord in a compact form.

### SUMMARY OF THE INVENTION

In the most basic form, the present invention comprises of a loop or a “C” shaped hook (hereafter “C-hook”) that holds a cord that has been wound into loops, and slots that allow an attached AC/DC adapter to plug into. There are no winding elements, users simply wind the cord into loops in their hands as they normally would. The wound cord is then inserted into the loop or C-hook, which holds it in place. The AC/DC adapter can be plugged into the slots. The slots are designed such that the adapter can be inserted in more than one orientation.

In a second embodiment, a back plate which contains the slots are attached to a base which contains the loop or C-hook. The back plate can be either parallel, perpendicular, or in some other orientation relative to the base. Different orientations can be designed to accommodate AC/DC adapters of different sizes and shapes, so that the bundled package is the most preferred.

A third embodiment is similar to the second, but the back plate is attached with a hinge, or some other kind of mechanism which allows it to move, rotate, or otherwise change its position or orientation relative to the base. This embodiment allows accommodation of AC/DC adapters of various sizes and shapes without any custom designs.

### BRIEF DESCRIPTION OF THE DRAWINGS

FIG. 1 is an illustration of an electrical cord and charger organizer, in accordance with an embodiment of the present invention.

FIG. 2 is the top view of the same apparatus shown in FIG. 1.

FIG. 3 is an illustration of an electrical cord and charger organizer, in accordance with an embodiment of the present invention.

FIG. 4 is an illustration of an electrical cord and charger organizer, in accordance with an embodiment of the present invention.

FIG. 5 is an illustration of the same apparatus shown in FIG. 4, but with the back plate rotated to a different position.

FIG. 6 is an illustration of the same apparatus shown in FIG. 4 being used to bundle an electrical cord with an attached AC/DC adapter.

FIG. 7 is an alternate view of the same apparatus shown in FIG. 6.

FIG. 8 is an illustration of the same apparatus shown in FIG. 1 being used to bundle an electrical cord with an attached AC/DC adapter.

FIG. 9 is an illustration of a potential design enhancement to the embodiment shown in FIG. 4.

FIG. 10 is an illustration of an enhanced design of the slots for the electrical pins of an AC/DC adapter.

### DETAILED DESCRIPTION

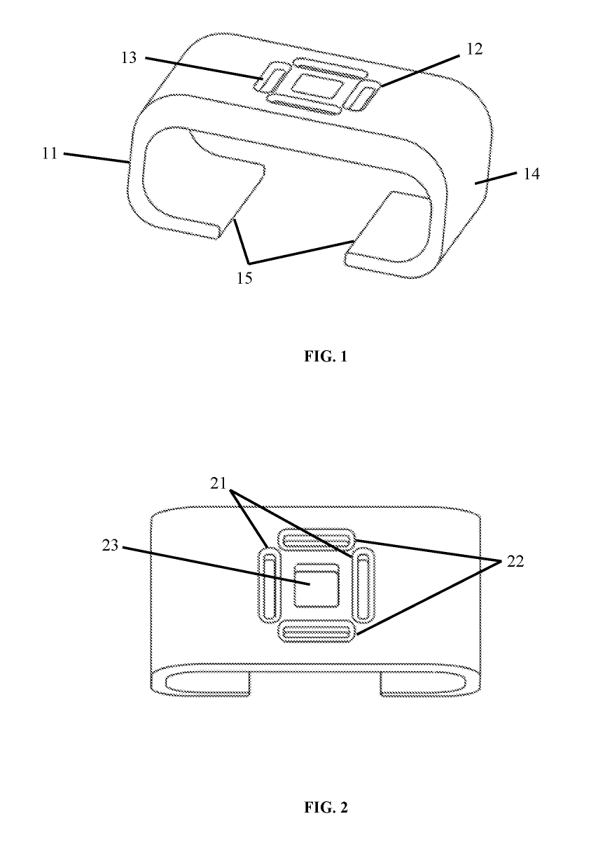

As illustrated in FIG. 1, the apparatus comprises mainly of (1) a rigid or stretchable loop, or a rigid “C” shaped hook (hereafter “C-hook”) 11 to keep an electrical cord in place and (2) slots 12 for electrical pins or blades (hereafter “pins”) of an AC/DC adapter to plug into. The slots may be chamfered 13 or rounded at the edges to make insertion of the pins easier.

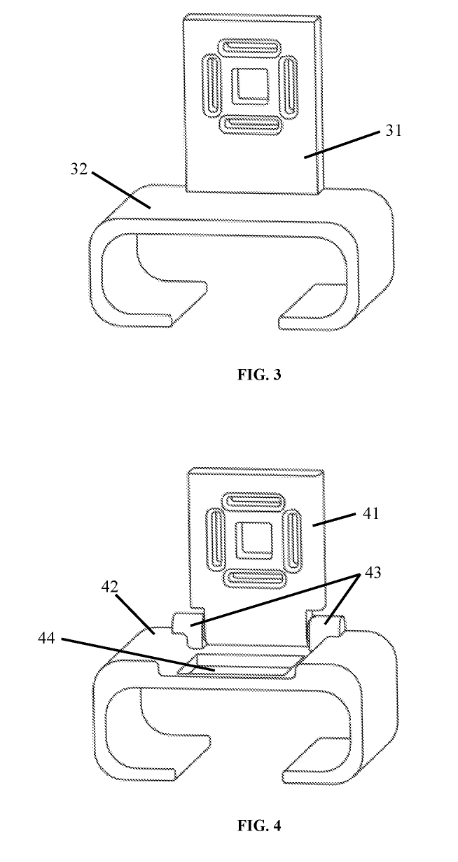

FIG. 2 shows the top view of the same apparatus shown in FIG. 1. Two sets of slots are provided (21 and 22) for standard U. S. plugs at the top of the C-hook. The AC/DC adapter can be plugged into either set. Since the slots need to hold the pins tightly, a relief cavity 23 is placed in the middle of the slots. The cavity allows the inside walls of the slots to deform slightly when pins are inserted to avoid pushing and deforming the pins. Relief cavities can also be placed adjacent to the outside edges of the slots to do the same.

FIG. 3 shows a second embodiment of the apparatus. In this embodiment, a back plate 31 that contains the slots is separated from a base 32 that contains the loop or C-hook, and is fixed perpendicular to the top surface of the base. This allows an AC/DC adapter to be plugged into the slots horizontally. This is convenient for AC/DC adapters that have tall bodies, which when plugged in horizontally, results in more compact form factors. Alternatively, the back plate can be attached to the base in parallel, or at an angle, or in any other conceivable orientation, whichever packs the intended battery charger into the most desirable form factor.

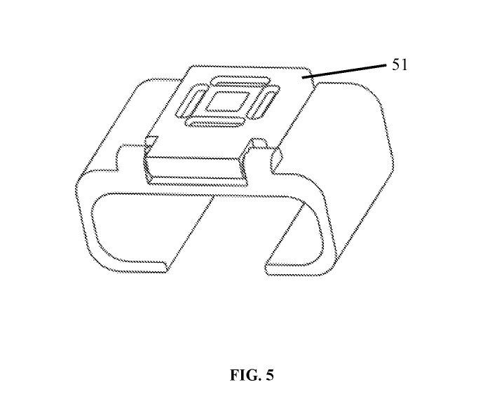

FIG. 4 and FIG. 5 depict a third embodiment of the device, which combines the first two embodiments. In this embodiment, the back plate 41 is connected to the base 42 via a hinge 43. The hinge can take many forms as long it allows the back plate 41 to freely rotate within a certain range. In particular, the back plate 41 is allowed to be rotated to either the upright position (as shown in FIG. 4) or the down position (as shown in FIG. 5). When the back plate 41 is rotated to the upright position, this embodiment functions similarly to the second embodiment shown in FIG. 3. When the back plate 51 is rotated to the down position, it functions similarly to the first embodiment shown in FIG. 1. A cavity 44 or a clearance is provided in the base 42 for the electrical pins to go through when the back plate 51 is rotated to the down position. Alternative designs for the hinge or other types of mechanical structures are also possible, in order to allow the back plate to change its orientation relative to the base.

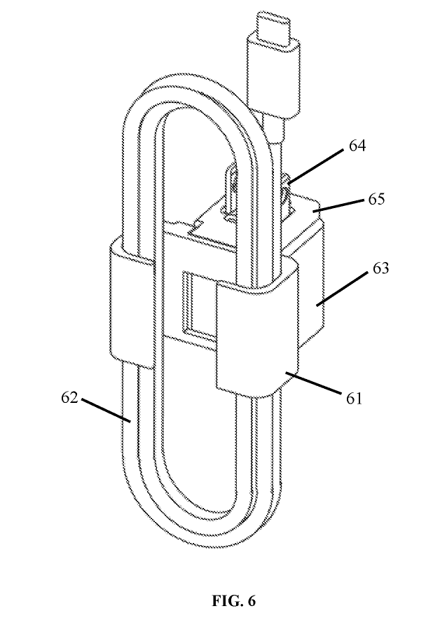

FIG. 6 shows the third embodiment of the device (as shown in FIG. 4) in use. A cord 62 that is attached to an AC/DC adapter 63 is held by the apparatus. The cord is wound into circular or oval shaped loops and is inserted into the base 61. The dimensions of the base 61 are designed so that the looped cord 62 is squeezed slightly in the middle where it tends to expand outward. This allows the cord to be held securely in place. The pins 64 of the AC/DC adapter 63 are inserted into one set of the slots in the back plate 65.

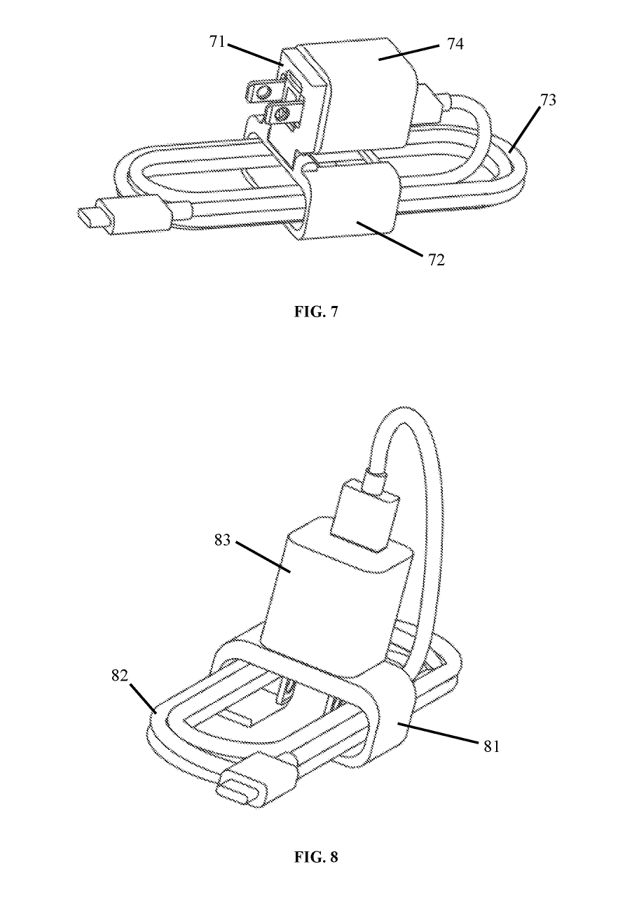

FIG. 7 shows the same thing as in FIG. 6 but in a different orientation. This orientation shows more clearly how the AC/DC adapter 74 is plugged into the back plate 71.

FIG. 8 shows the first embodiment of the device 81 (as shown in FIG. 1) holding the same cord 82 and AC/DC adapter 83, but with the AC/DC adapter 83 plugged into the slots vertically. The looped cord 82 is inserted into the base the same way as shown in FIG. 6. Although the first embodiment is shown in this figure, the third embodiment with the back plate 51 flipped to the down position, as shown in FIG. 5, can be used in the same fashion.

Many variations of the design of this device can be made to accommodate different functional and aesthetic requirements. For example, the base part of the device in all figures appears rectangular, with flat side walls 14. This allows the apparatus to stand on its side. However, it can be made into a circular or an oval shape with rounded side walls for aesthetic reasons. The base can also be made into a single rigid or a stretchable loop, by connecting the ends of the C-hook 15. A stretchable loop would function similarly to a rubber band. Alternatively, the loop can also be a Velcro band, or a strip with another locking mechanism. For another example, even though two sets of slots (21 and 22) are provided in all embodiments to accommodate a variety of AC/DC adapters, in certain cases, such as when the apparatus is designed for a specific AC/DC adapter, only one set is necessary.

FIG. 9 illustrates a design variation that may enhance the device. This figure shows the exact same embodiment as shown in FIG. 4, except that a gap 91 is inserted in the middle of each hook. The gap may be useful when a small strand of the cord needs to be held outside of the loop. The strand can be threaded through the gap, which, along with the loops that remain inside the base 92, holds it securely in place. Multiple gaps can be used depending on the application.

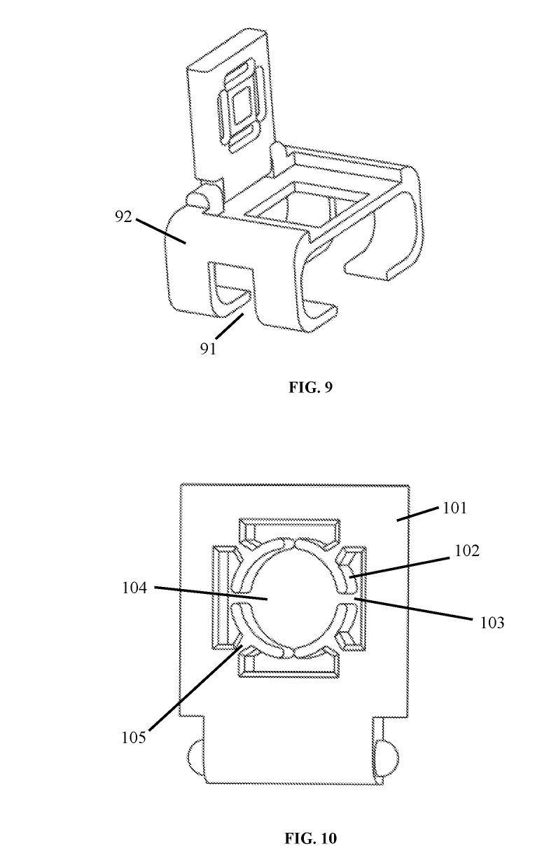

FIG. 10 shows an alternate embodiment of the inner walls of the slots. The figure only shows the back plate 101. If the slots were made with common rigid plastic material, the inner walls, even with a stress-relief cavity 23 as shown in FIG. 2, does not bend very much. Due to manufacturing tolerances, the slots may be slightly too wide, in which case the pins cannot be held securely, or slightly too narrow, which makes inserting the pins difficult. In this embodiment, the straight inner slot walls are replaced by circular ones 102, with a gap 103 inserted in the middle of each slot. Due to the gaps in the middle, the walls are supported by spokes 105. The relief cavity 104 remains but has a circular shape. The circular inner walls 102 with gaps in the middle 103 would bend more readily, creating a spring effect. As a result, the slot width can be made slightly narrower than the electrical pins. The inner walls would deform slightly while the pins are inserted, making the process easier. The walls would then push against the pins to hold them more tightly.

Finally, although the pin slots are designed for standard U.S. plugs with two pins (i. e. no ground pin), it is simple and straightforward to re-configure them to add a ground pin or to accommodate various international plug styles.

### REFERENCE NUMERALS

11. “C” shaped hook, or C-hook
12. Slots for an AC/DC adapter's electrical pins to plug into
13. Chamfered or rounded edges
14. Side wall
15. Ends of the C-hook
21. Slots for an AC/DC adapter to be inserted horizontally
22. Slots for an AC/DC adapter to be inserted vertically
23. Cavity for stress relief
31. Back plate containing slots
32. Base of the apparatus containing a C-hook
41. Back plate with the slots, rotated to the upright position
42. Base of the apparatus containing a C-hook
43. Hinges that allow the back plate to rotate
44. Cavity that allows the pins to go through
51. Back plate flipped to the down position
61. Base part of the same apparatus shown in FIG. 4
62. A wound cord inserted into the base
63. An AC/DC adapter
64. Pins of the AC/DC adapter inserted into a set of slots
65. Back plate of the apparatus
71. Back plate of the apparatus
72. Base of the apparatus
73. Cord wound into loops held by the apparatus
74. AC/DC adapter
81. The embodiment as shown in FIG. 1
82. Cord wound into loops and held by the apparatus
83. AC/DC adapter
91. Gap
92. Base part of the apparatus
101. Back plate
102. Circular inner slot wall
103. Gap
104. Relief cavity
105. Spoke

### Operation of the Apparatus in an Exemplary Embodiment

In order to operate this apparatus, please refer to FIG. 6. First wind the cord into loops 62 by hand or by a winding device (not included as part of the present invention). Then insert the looped cord into the base part 61 of the apparatus. If the third embodiment as shown in FIG. 4 and FIG. 5 is used, flip the back plate 65 to either the upright (as shown in FIG. 4) or down position (as shown in FIG. 5), whichever results in a more preferred overall form factor. Finally, plug the AC/DC adapter 63 into a preferred set of slots in the back plate 65. If an AC/DC adapter is not attached, the device can still be used to hold the looped cord in place.

1. An apparatus capable of bundling an electrical cord that is attached to an AC/DC adapter into a compact form factor, comprising:
a. a rigid or stretchable loop, or a rigid C-hook, capable of holding said electrical cord in place, and
b. at least one set of slots that allows a plurality of electrical pins of said AC/DC adapter to be plugged into,
whereby said loop or said C-hook holds said electrical cord in place after said electrical cord is wound into loops of circular or oval shapes, and said slots hold said AC/DC adapter together with said looped electrical cord in a compact form factor.

2. The apparatus of claim 1 wherein said rigid or stretchable loop or said C-hook is separate from said slots, comprising:
a. a base which comprises said rigid or stretchable loop, or said rigid C-hook,
b. a back plate comprising at least one set of said slots, and
c. with said base and said back plate connected either in parallel, perpendicular to each other, or in another orientation,
whereby said base and said back plate are connected at an orientation so that said electrical cord that is attached to said AC/DC adapter is bundled in a most preferred form factor.

3. The apparatus of claim 2 wherein said base and said back plate are connected via a hinge or a mechanical structure which allows said back plate to change its orientation relative to said base,
whereby by allowing said back plate to change its orientation relative to said base, said apparatus is capable of bundling said AC/DC adapter of a variety of sizes and shapes into a preferred form factor.

4. A construction of said set of slots, comprising:
a. Two sets of parallel slots arranged perpendicular to each other in a square fashion, and
b. A set of circular inner walls, with a gap located in the middle of each slot,
whereby set circular inner walls would deform slightly when a plurality of electrical pins of said AC/DC adapter are inserted into said slots, thereby making insertion of said electrical pins easier and said slots holding onto said electrical pins more tightly.

5. The construction of claim 4 wherein said set of slots comprising one set of at least three slots,
whereby said constructions is capable of accepting said AC/DC adapter with more than two electrical pins.
